(19) United States
(12) Patent Application Publication
(10) Pub. No.: US 2018/0375669 A1
(43) Pub. Date: Dec. 27, 2018

(54) METHOD FOR GENERATING A CHALLENGE WORD, ELECTRONIC DEVICE, SET VALUE PERIPHERAL, AND SYSTEM IMPLEMENTING SAID METHOD

(71) Applicant: ABC SMART CARD, Marseille (FR)

(72) Inventor: Hervé ABEL, Le Rove (FR)

(21) Appl. No.: 16/062,216

(22) PCT Filed: Dec. 16, 2016
(86) PCT No.: PCT/FR2016/053511

§ 371 Date: Jun. 14, 2018

(30) Foreign Application Priority Data
Dec. 17, 2015 (FR) 1562677

(51) Int. Cl. H04L 9/32; G06F 21/45; G06F 21/36; G06F 17/22

(52) U.S. Cl. CPC H04L 9/3271; G06F 21/45; G06F 21/36; H04L 2209/34; G06F 2221/031; G06F 2221/2111; G06F 17/2217

(57) ABSTRACT

Method for generating a challenge word, electronic device, input peripheral, and system implementing said method. The invention relates to a system and to a method for generating a challenge word (WCH) that is intended to be used in the context of an authentication request (Mi). Such a system particularly relies on an electronic device (10) and an input peripheral (20) that are in communication (NI) with each other. The challenge word (WCH) is produced by said system on the basis of a candidate word (WCD) generated by said electronic device (10) and a piece of input information (IC) generated by said input peripheral (20). The invention offers a robust alternative to the major attacks experienced when entering a secret challenge word on a physical or virtual keyboard.

The present invention relates to a method for generating a challenge word that is intended to be used in the context of an authentication request. The object of the invention more specifically lies in allowing a physical person to authenticate themself in order to benefit from a service without having to directly enter a challenge word, the content of which is kept secret by said physical person, by means of a human-machine interface such as a keyboard. The invention also relates to a system making it possible to implement a process of this kind for generating a challenge word. A system of this kind is based in particular on electronic objects in communication with one another. The invention offers a solution responding to the major attacks known when entering a challenge word, for example in the form of a secret password, said challenge word being known generally by the term “PIN code” (Personal Identification Number code) when it corresponds to a personal identification code or number.

There are numerous techniques allowing a physical person to authenticate themself to a machine, such as a cashpoint machine or a machine providing foodstuffs, goods or a service, with an access control keypad controlling an electronic lock, a computer, or more generally any electronic object. Among the main techniques, we have mentioned the entering of a challenge word, the content of which is known in principle only by said physical person. In a variant, other techniques utilize a biometric recording of a piece of physiological data of the person, instead of a challenge word of the above-mentioned kind. Thus, it is possible to capture a digital fingerprint or retinal scan of a subject after a prior enrollment step. A print or scan of this kind is intended to distinguish said subject from other human beings. However, the equipment required in order to implement in particular the step of capturing information is costly and vulnerable. The prior step of enrollment also requires a process that is restrictive for the individual concerned. On the other hand, a technique of this kind has further disadvantages in the sense of inhibiting security. In fact, captured information, in particular a biometric fingerprint, can leave behind a trace, which in turn can be captured and then reproduced by a malicious entity. The entering of a secret challenge word is thus generally preferred. However, this technique also has weaknesses in respect of security. In order to attempt to prevent any malicious interception or learning of the value of said challenge word by a malicious entity, some manufacturers of physical keyboards have opted for the addition of sensors detecting any attempt of physical intrusion or alteration of the integrity of said keyboard. Others have also opted to implement cryptographic procedures in order to encrypt and/or sign the transmission of the value of the challenge word. The sought objective lies in maintaining the confidentiality of the value of said challenge word during communication thereof to an entity tasked with implementing a procedure of authentication or identification on the basis of said challenge word. A procedure of this kind generally lies in performing a comparison of the content of said challenge word with that of a reference word, recorded in a secure manner by a trustworthy third party or in a memory having restricted access. A solution of this kind aimed at designing secure physical keyboards has proven to be costly, complex and incompatible with small electronic objects, because it requires the integration of a multitude of hardware, electronic, mechanical and computer means for implementing cryptographic procedures. Regardless of the design of a keyboard of this kind, a malicious or cleverly positioned individual can glimpse the input or the display of the characters of the secret word on the input or output interface of the apparatus at which a person enters the secret content of a challenge word, such as a PIN code.

In order to attempt to overcome these limitations, but also allow secure access to certain pages or applications accessible via an Internet navigator, some manufacturers are proposing a virtual keyboard. A keyboard of this kind generally comprises as many virtual keys as there are possible symbols for a character of said challenge word. Said keys are displayed on a screen. It is possible to select them by means of a cursor that can be moved with the aid of a pointing peripheral, for example a mouse or a touchpad. A solution of this kind is currently used in order to protect the connection of an individual or company to an online bank. So that the content of the challenge word, input via said keyboard, cannot be easily captured maliciously as it is entered and/or transmitted, the position of each key of the virtual keyboard displayed on the screen is random or pseudorandom. As soon as the set of characters of the challenge word has been input in the form of a selection of symbols, the content of said challenge word resulting from the concatenation of said characters is encoded and transmitted to the entity tasked with implementing the procedure of authentication. Although a solution of this kind improves the security of the entering of a secret challenge word in an economical way, it has proven vulnerable to the use of malicious software, possibly installed without the knowledge of the user of an electronic object into which said user enters the content of a challenge word. A malicious software of this kind, generally referred to as a “Trojan”, uses a screenshot, not discernible by the user as he/she enters the challenge word, and thus obtains the content of the various characters of said challenge word. In addition, the use of virtual keyboards is not easy because an application platform implementing a solution of this kind must comprise a secured and multi-operable environment.

The invention makes it possible to overcome the disadvantages described above of the known solutions by proposing a method for generating a challenge word implemented by a processing unit of an electronic device cooperating with an input peripheral. In contrast to the known solutions, the action of a physical person during the step of “entering” of the characters forming a challenge word is not manifested by the action of a physical or virtual touching of a keyboard showing the selected symbol. The action of said user via said input peripheral is manifested only by an exchange of data between said input peripheral and said electronic device, wherein this data, although possibly captured fraudulently, is itself insufficient to reveal the content of a challenge word. By way of non-limiting example, an electronic device adapted in accordance with the invention can consist of an electronic watch or any other personal accessory, such as a pair of electronic glasses, an earpiece or an item of jewelry, by way of non-limiting example. It is sufficient that said electronic device is equipped with a human-machine output interface making it possible for the characters of a candidate word to be input in a manner that is perceptible by the user of said device (graphic, sound, etc.), the characters of said candidate word being different from those forming the future challenge word produced by said electronic device. Similarly, by way of non-limiting example, an input peripheral adapted in accordance with the invention can consist of a smartphone, a tablet, or any other piece of equipment or electronic object designed to communicate with the electronic device described above and comprising an input human-machine interface making it possible to translate a gesture or more generally an action performed by the user into data utilized by the electronic device jointly with the content of the candidate word in order to produce the challenge word securely.

The invention provides numerous advantages, including the following:
it proposes a system that is particularly robust to the known attacks experienced when entering secret challenge words;
it does not require an input interface and more generally an input peripheral that is particularly secured, unlike the known physical and virtual keyboards, since the data provided by said input peripheral do not themselves make it possible to obtain the secret content of a challenge word produced in accordance with the invention;
it can reduce the input peripheral to its simplest expression, thus reducing the capital outlay as well as the costs for maintenance thereof.

To this end, the invention relates to a method for generating a challenge word implemented by a processing unit of an electronic device further comprising an output interface, means for controlling said output interface, first communication means for cooperating with an input peripheral, first storage means, and a sensor for cooperating with the user of said electronic device and measuring a physiological variable of said user, said means for controlling said output interface, said first communication means, said first storage means and said sensor cooperating with said processing unit.

In order to securely produce a challenge word of this kind and thus prevent the known attacks, said method comprises:
a step of collecting and analyzing the information provided by the sensor and confirming that the electronic device is in the direct vicinity of said user;
a step of producing a candidate word comprising a character consisting of a value selected from an organized list of n predetermined symbols indicated individually by the value of an index, n being an integer greater than one, said list being stored in the first storage means;
a step of triggering the means for controlling the output interface and outputting said candidate word via said interface;
a step of receiving an input message, via said first communication means, and of decoding a message of this kind and deducing therefrom a piece of input information produced by said input peripheral;
a step of producing the challenge word, the character of which at a given position consists of one of the predetermined symbols contained in said organized list, said symbol being indicated by an index value that is a function of that indicating the value of the character of the candidate word in the same position and the input information.

In accordance with an advantageous embodiment and in order to prevent any new production of a challenge word while the electronic device is kept in the direct vicinity of its user, the step of producing the challenge word possibly also consists of recording the value of said produced challenge word in the first storage means.

By contrast, should said electronic device be removed from the immediate vicinity of said user, it can be requested to produce a new challenge word. Thus, a method of this kind can comprise a step of replacing the value of the challenge word recorded in the first storage means by a predetermined value characterizing a deletion if the step of collecting and analyzing the information provided by the sensor confirms that the electronic device is not in the direct vicinity of said user.

In accordance with a second advantageous embodiment, the invention also provides that a method of this kind can comprise a step of generating a solicitation message intended for the input peripheral and of triggering the transmission of said solicitation message by the first communication means.

In order to implement a procedure of authentication on the basis of a challenge word requested by a third-party electronic entity, an electronic device implementing a method according to the invention can advantageously comprise second communication means for cooperating with said third-party entity. In this case, a method for generating a challenge word in accordance with the invention can comprise:
a step, prior to the step of producing a candidate word, of receiving, via the second communication means, an incoming message transmitted by said third-party entity requesting the production of the challenge word, so as to decode said message and so as to deduce therefrom an identifier of said third-party entity;
a step, subsequent to the step of producing said challenge word, of generating an outgoing message encoding the challenge word and of triggering the transmission thereof by the second communication means.

In order to implement a procedure of authentication of this kind on the basis of a challenge word without the need to solicit the input peripheral when the electronic device has remained in the immediate vicinity of its user, the invention provides that:
the steps of, respectively, producing a candidate word and/or the challenge word can be implemented only if the value of the challenge word recorded in the first storage means is equal to the predetermined value characterizing a deletion;
the step of generating an outgoing message can consist of reading the value of the challenge word into the first storage means prior to the encoding of said challenge word in order to generate the outgoing message.

In addition, in order to preserve the confidentiality of the challenge word, it is advantageous that the step of generating an outgoing message can be implemented only if the step of collecting and analyzing the information provided by the sensor confirms that the electronic device is in the direct vicinity of said user.

Generally, a challenge word contains a plurality of characters. In this case, the method for generating a challenge word can be adapted so that the candidate word and the challenge word comprise a plurality of characters consisting, respectively, of one of the symbols selected from the organized list of predetermined symbols.

So that a user of an electronic device implementing a method according to the invention can be sure that his/her action during the generation of the challenge word is correct, said method can comprise advantageously a step of triggering the means for controlling the output interface and outputting, via said interface, the produced character of the challenge word, instead of the character of the candidate word in the same position, then, once a specific waiting period has elapsed, triggering the means for controlling the output interface and outputting, via said interface, a neutral symbol instead of said challenge word character.

In the case in which the content of a character of the candidate word should correspond by chance to that of the character of the challenge word to be produced in the same position, a method according to the invention provides that the step of producing a character of the challenge word in a given position consists of the value of the character of the candidate word in the same position if no input message is received by the first communication means at the end of a specific waiting period starting from the transmission of the solicitation message. Thus, the absence of any action via the input peripheral can be taken into consideration by the electronic device implementing a method of this kind.

In accordance with a preferred embodiment the invention provides that the input information can comprise advantageously a value expressing a relative step in respect of the index value indicating the predetermined symbol associated with a character of the candidate word.

In this case, the step of producing a character in a given position of the challenge word can consist of choosing one of the predetermined symbols contained in said organized list, said symbol being indicated by an index value which is the sum, modulo the number n of predetermined symbols in said list, of the index value indicating the predetermined symbol of the character of the candidate word in the same position and of the value expressing the relative step comprised in the input information.

In accordance with a second subject, the invention also relates to a computer program product comprising program instructions which, when they are:
stored beforehand in the second storage means of an electronic device comprising a processing unit, first storage means, an output interface, communication means for cooperating with a third-party device, and a sensor for cooperating with the user of said electronic device and measuring a physiological variable of said user, said output interface, said communication means, said first and second storage means and the sensor cooperating with said processing unit;
executed or interpreted by said processing unit,
cause the implementation of a method for generating a challenge word according to the invention.

In accordance with a preferred exemplary embodiment, the invention provides that an electronic device of this kind can advantageously consist of an electronic watch, the output interface of which consists of the screen of said watch.

In accordance with a third subject, the invention relates to a system for generating a challenge word, comprising an electronic device and an input peripheral according to said invention.

A system of this kind can also comprise a third-party electronic entity requesting a procedure of authentication on the basis of the challenge word, said entity cooperating with the electronic device of said system.

Further features and advantages will become clearer upon reading the following description and examining the accompanying drawings, in which:

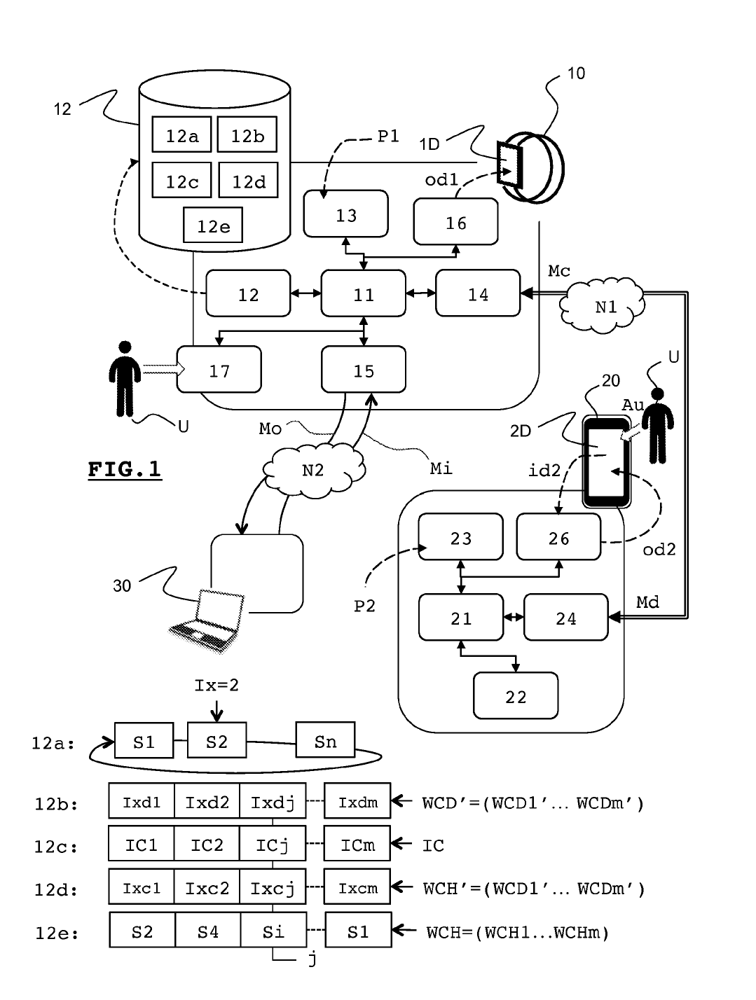

FIG. 1 shows a functional architecture of a system for generating a challenge word according to the invention;

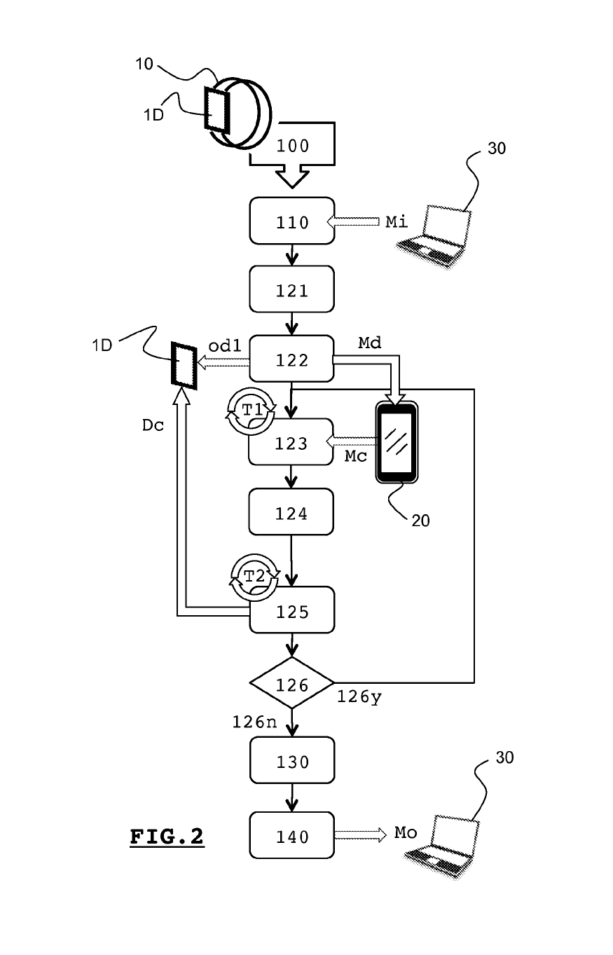

FIG. 2 describes a method for generating a challenge word of this kind implemented by an electronic device of a system as presented by way of example by FIG. 1;

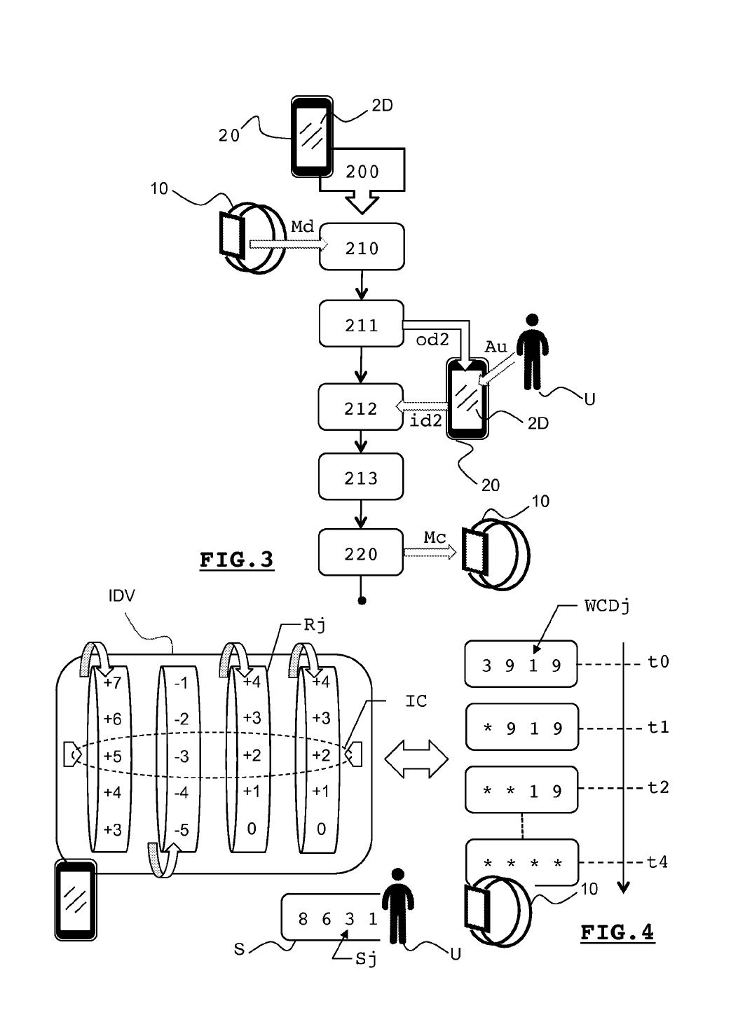

FIG. 3 describes a method for generating a piece of input information implemented by an input peripheral of a system described by way of example by FIG. 1;

FIG. 4 illustrates an exemplary application of a system for generating a challenge word in the form of a word having four characters associated, respectively, with symbols belonging to an organized list of Arabic numerals comprised between ‘0’ and ‘9’.

FIG. 1 describes a preferred exemplary embodiment of a system for generating a challenge word WCH requested for example by an electronic entity 30. A system of this kind comprises in particular two electronic objects in the form of an electronic device 10 and an input peripheral 20. By way of preferred non-limiting example, an electronic device 10 according to the invention consists of an electronic watch worn by a user U. In a variant, a device 10 of this kind could consist of a pair of interactive glasses, a piece of electronic jewelry, or any other personal accessory that can be adapted in accordance with the invention. For its part, an input peripheral 20 can consist for example of a smartphone or an interactive tablet, or a personal computer.

So as to be able to implement a method 100 for generating a challenge word WCH, said method 100 being described subsequently with reference to FIG. 2, an electronic device 10 comprises a processing unit 11, for example in the form of one or more microcontrollers, cooperating with storage means, in the form of a data memory 12, possibly a program memory 13, said memories 12 and 13 possibly being separate or forming a single physical entity, or one of said memories possibly being wholly or partially distanced, for example housed by a server (not shown in FIG. 1).

The electronic device 10 can be solicited by a remote electronic entity 30, in the form of an application server or a trusted electronic third-party server, said entity 30 implementing a procedure of authentication on the basis of the provision of a challenge word WCH, the content of which is compared for example to that of a reference word. In this case, a request to generate a challenge word can be transmitted to the electronic device 10 in the form of an incoming message Mi via a communication network N2, for example of the Internet or intranet type. The electronic device 10 may therefore comprise communication means 15 designed to secure remote communication of this kind by encoding and/or decoding messages.

In fact, following generation of a challenge word WCH by said electronic device 10, the content of said challenge word WCH can be encoded and then transmitted by said communication means 15 to said entity 30, in the form of an outgoing message Mo via said communication network N2. In a variant, a communication network N2 of this kind can be provided by way of a wired connection between the device 10 and the entity 30. In accordance with another variant, said electronic device 10 and said entity 30 can constitute merely a single physical entity, the processing unit 11 of which implements two processes: one for soliciting and processing the generation of a challenge word WCH and the other for actually generating said challenge word.

When the storage means 12 and/or 13 are within the electronic device 10, the processing unit 11 cooperates, similarly to other internal elements, with said means 12 and/or 13 by one or more communication buses, shown in FIG. 1 by a double arrow. An electronic device 10 comprises communication means 14 provided for communication with one or more input peripherals 20, for example a smartphone, via a communication network N1. Communication of this kind can be performed wirelessly, via a proximity-based communication protocol, such as Bluetooth or ZigBee technology. In a wired variant said communication can be performed via a protocol of the USB or FireWire type, in accordance with two non-limiting protocol examples.

In accordance with a preferred, but optional embodiment, an electronic device 10 can comprise or cooperate with one or more sensors 17. A sensor 17 of this kind is advantageously selected to measure a physiological variable of the user or owner U of said electronic device 10. The objective is to assure that the generation of a challenge word WCH is performed on the basis of proven immediate proximity, or direct contact, of said electronic device 10 with its user U. To do this, a sensor 17 of this kind cooperates with the processing unit 11 of said electronic device 10.

An exemplary sensor 17 can be selected or designed to measure the body temperature, pulse, or heart rate of said user U. The invention shall not be limited by the utilization of these examples of measurements of physiological constants. It can be seen, in conjunction with FIG. 2, that the measurement provided by the sensor 17 can be utilized in order to detect a discontinuity of contact or immediate proximity of the electronic device 10 and its user U for security purposes.

The electronic device 10 also comprises an output interface 1D cooperating with the processing unit 11. According to FIG. 1, said interface 1D is controlled by control means 16 separate from said processing unit 11. In accordance with a second embodiment, the means 16 and the processing unit 11 may constitute merely a single physical entity. Said control means 16 then constitute the processing unit 11. According to FIG. 1, said means 16 are triggered by said processing unit 11, via content output commands od1, so as to cause information to be output in a manner perceptible by the user U. An output of this kind is advantageously a graphical output. In a variant or in addition, it could be a sound-based output. The interface 1D can thus output content in the form of text, a graphical illustration, or a videogram or a soundtrack. More generally, content of this kind shall be referred to as “multimedia content”, with no limitation in respect of format or output mode.

An interface of this kind 1D can thus advantageously consist of one or more screens, one or more loudspeakers, or more generally said interface 1D can comprise any means able to provide information perceptible by a human being. An output interface of this kind 1D can be arranged within the electronic device 10 or can cooperate therewith remotely. In accordance with this variant, the invention thus provides the possibility of utilizing a screen, for example, of a third-party electronic device. However, the output of multimedia content is triggered by the processing unit 11 of the electronic device 10.

An electronic device 10 according to the invention may advantageously comprise an optional input interface (not shown in FIG. 1), for example in the form of a keyboard or a microphone or, more generally, any means allowing a human to interact with the device 10 in order to input information therein. An optional input interface of this kind can translate parameterization information communicated in particular by the user U into parameterization data transmitted, in turn, to the processing unit 11 via a communication bus or via coupling. Parameterization data of this kind can consist of preferences for configuring the output interface 1D and thus selecting a particular output mode or, more generally, for parameterizing the functioning of the electronic device 10. In accordance with an advantageous embodiment, an input interface of this kind can be combined with the output interface 1D and can consist for example of a touchscreen.

So as to be able to implement a method for generating a challenge word WCH in accordance with the invention, the storage means, for example the memory 13, can comprise program instructions of a computer program product P1, the interpretation or execution of which by the processing unit 11 adjusts the functioning of said electronic device 10, causing said electronic device to implement a method for generating a challenge word WCH in accordance with the invention. The storage means, for example the memory 12, advantageously comprise data structures 12a, 12b, 12c, 12d or 12e, the respective contents and uses of which will be detailed with reference to FIGS. 1 and 2 in the detailed description of a preferred exemplary embodiment of the method 100 according to the invention.

FIG. 1 describes a system according to the invention comprising an input peripheral 20, such as a mobile phone or a touchscreen tablet, for example. More generally, an input peripheral 20 of this kind consists of an electronic object communicating with the electronic device 10 via the connection N1. Similarly to the electronic device 10, an input peripheral 20 comprises a processing unit 21, for example in the form of one or more microcontrollers, cooperating with storage means, in the form of a data memory 22, possibly a program memory 23, said memories 22 and 23 possibly being separate or forming a single physical entity.

The input peripheral 20 can be solicited by the electronic device 10. In this case, a request to generate a piece of input information can be transmitted to the input peripheral 20 in the form of an incoming message Md via the communication network N1. Communication of this kind can be performed wirelessly, via a proximity-based communication protocol, such as Bluetooth or ZigBee technology, or any other alternative technology. The connection N1 can be provided in the form of a wired variant, for example via a protocol of the USB or FireWire type. The input peripheral 20 comprises communication means 24 designed to secure proximity-based communication of this kind by encoding and/or decoding messages. In fact, after generation of a piece of input information IC by the input peripheral 20, the content of said input information IC can be encoded and then transmitted by said communication means 24 to the electronic device 10 in the form of an outgoing message Mc via said communication network N1.

The storage means 22 and/or 23 cooperate, similarly to other internal elements, with the processing unit 21 by one or more communication buses, shown in FIG. 1 by a double arrow.

The input peripheral 20 also comprises an input interface 2D cooperating with the processing unit 21. According to FIG. 1, said interface 2D is controlled by control means 26 separate from said processing unit 21. In accordance with a second embodiment, the means 26 and the processing unit 21 can constitute merely a single physical entity. The control means 26 and the processing unit 21 then constitute the same physical entity, without distinction. According to FIG. 1, said means 26 are triggered by said interface 2D translating a gesture or an action Au of the user U detectable by said interface 2D into input data id2 communicated to the processing unit 21.

An input peripheral of this kind 20 can also comprise an output interface (not shown by FIG. 1), said output interface possibly being combined with the input interface 2D. An optional output interface of this kind makes it possible to provide content perceptible by the user U, in the form of text, a graphical illustration, or a videogram or a soundtrack. More generally, content of this kind shall be referred to as “multimedia content” with no limitation in respect of format or output mode. An output interface of this kind can thus advantageously consist of one or more screens, or one or more loudspeakers. An output interface of this kind 2D can be arranged internally of the input peripheral 20 or can cooperate therewith remotely. In accordance with this variant, the invention thus provides the option to utilize a screen, for example of a third-party electronic object. However, the output of multimedia content is triggered by the processing unit 21 of the input peripheral 20, possibly via means for controlling said output interface, for example the means 26.

An input peripheral 20 according to the invention can advantageously comprise a mixed input and output interface, for example in the form of a touchscreen or any means enabling a human being to interact with the input peripheral 20. The input interface 2D can optionally translate parameterization information in particular communicated by the user U into parameterization data transmitted, in turn, to the processing unit 21 via a communication bus or via coupling. Parameterization data of this kind can consist of preferences for configuring the input and/or output interface 2D, and thus selecting a particular output mode or, more generally, for parameterizing the functioning of the input peripheral 20. The primary utilization, within the context of the invention, of the interface 2D lies in translating an action Au performed by the user U of said input peripheral 20 into a piece of user input data id2 so that the processing unit 21 produces a piece of input information IC by implementing a method 200 for generating said piece of input information IC, said method being described subsequently with reference to FIG. 3 in particular.

So as to be able to implement a method of this kind 200, the storage means 23 can comprise program instructions of a computer program product P2, the interpretation and/or execution of which by the processing unit 21 adjusts the functioning of said input peripheral 20 by causing the implementation of a method for generating a piece of input information IC according to the invention by said input peripheral.

FIG. 1 also describes, by way of non-limiting example, a mode for managing the storage means 12 cooperating with the processing unit 11 of an electronic device 10 adapted in accordance with the invention. A first data structure 12a is thus provided in order to store an organized list or table of n predetermined symbols S1, S2, . . . , Sn, n being an integer greater than or equal to two. Each symbol or value representative of a symbol of this kind, for example a numerical integer value between the integers 0 and 9, or graphical or figurative symbols or sounds, can be indicated individually by the value of an index Ix. Thus, when said index assumes the value 2, the symbol stored in the second position in said organized list is indicated. Any other equivalent technique could be used instead of, or in addition to said indexing of the list of determined symbols.

The example described with reference to FIG. 1 corresponds to the generation of a challenge word WCH comprising m characters WCH1 to WCHm, each character assuming, as its value, the value of one of said symbols of said organized list stored at 12a. By way of non-limiting example, the value m can assume an integer value not equal to zero, comprised between 4 and 8. In fact, the majority of secret words comprise a number of characters less than or equal to 8, typically 4. However, the size of a challenge word WCH shall not limit the invention in any way. A challenge word of this kind WCH is stored in the storage means 12, advantageously in a data structure referenced 12e in FIG. 1, after having been produced by the system according to the invention. It shall be seen, in conjunction with the detailed description of a method 100 for generating a challenge word of this kind WCH described in FIG. 2, that said generation is based on the generation of a candidate word WCD, comprising, similarly to the challenge word WCH, m characters of which the respective contents correspond to one of the n symbols comprised in the organized list stored at 12a. A candidate word of this kind WCD can be generated in a random or pseudorandom manner. It therefore has every chance of being different from the challenge word WCH which the method 100 generates and the content of which is intended to be stored only in the actual physical memory of the user U. A candidate word of this kind WCD can be stored at the time of its generation by the electronic device 10 in a structure within the storage means 12, similarly to the word WCH. In a variant, and as described in a non-limiting manner by FIG. 1, a data structure 12b can comprise, for the m characters of said candidate word WCD, the respective index values Ixd1 to Ixdm, each indicating the symbol associated with one of the m characters of said candidate word WCD. The structure 12b thus expresses a representation WCDj′ of the candidate word WCD insofar as, for this, each element WCD1′ to WCDm′ encodes a value of the index Ix associated with the organized list recorded in the data structure 12a.

The storage means 12 can advantageously (although this is not limiting) comprise a structure 12d expressing a representation WCH′ of the challenge word WCH per se, in accordance with which representation each element WCH1′ to WCHm′ encodes a value Ixc1 to Ixcm of the index Ix associated with the organized list stored at 12a.

The storage means 12 can also comprise a structure 12c designed to store a piece of input information IC produced by the input peripheral 20, as will be seen with reference to FIG. 3, which shows a method 200 implemented by said peripheral 20. In accordance with certain embodiments, a piece of information of this kind IC could itself comprise m fields, each encoding an index increment. In accordance with this embodiment the storage means 12 could comprise a data structure 12c, each field of which would consist of a piece of information IC1 to ICm relating to the candidate word WCD. Any other information IC could be stored instead of the structure 12c described in FIG. 1.

Let us now study a non-limiting example of a method 100 for generating a challenge word WCH with reference to FIGS. 1, 2 and 4. FIG. 4 in fact describes a non-limiting example of application of a system for generating a challenge word WCH of m=4 characters WCH1 to WCH4. It should be noted that this number m of characters of the challenge word WCH does not in any way limit the invention. In accordance with this example, the storage means 12 of an electronic device 10, such as that described with reference to FIG. 1, comprises an organized list 12a of n=10 predetermined symbols corresponding respectively to the Arabic numerals ‘0’ to ‘9’. Thus, the challenge word to be produced by the invention assimilates a personal identification code formed of four characters associated with one of the n=10 symbols S1=‘0’, S2=‘1’, S3=‘2’, . . . , S10=‘9’. Any other symbol, possibly figurative, could be utilized instead of Arabic numerals as stated above by way of non-limiting example. In accordance with our example, a user U stores in his/her head the content “8 6 3 1” of a secret word S in the form of a personal identification code.

FIG. 4, on the left-hand side, describes an example of a graphical interface IDV, provided by an input peripheral 20, showing graphically a series of virtual encoder wheels Rj, j being able to assume an integer value comprised between one and four. An encoder wheel Rj is associated with the character WCHj of the challenge word that is to be produced in accordance with the invention. The virtual encoder wheel Rj comprises an entire relative range, for example between −5 and +5, which makes it possible to choose an integer value relative to an index value indicating the symbol of the character WCDj of a candidate word WCD, the latter being provided by the output interface 1D of an electronic device, such as the device 10 described in conjunction with FIG. 1. Said output interface 1D thus displays to the user U a candidate word WCD of content “3 9 1 9”. The object of the invention thus lies in asking the user U of the input peripheral 20 to choose a relative index step or increment in respect of the symbol associated with each character of the candidate word WCD, such that the initial symbol of the character of said candidate word WCD is substituted mentally by the symbol associated with the character in the same position of the secret word S. In accordance with this example described in conjunction with FIG. 4, a piece of input information ICn generated by the input peripheral 20 corresponds to an item of data comprising m=4 fields IC1 to IC4, transmitted by said peripheral 20 to said electronic device 10 in the form of an input message Mc. The content of said information consists of encoding four relative steps “‘+5’, ‘−3’, ‘+2’”, associated respectively with the m characters of the candidate word WCD, such that the content of the secret word S is substituted with that of the candidate word WCD. In accordance with this preferred embodiment, the input information IC can comprise m=4 fields IC1 to IC4 each comprising a relative integer value between −5 and 5. Said information IC is stored in the structure 12c within the storage means 12.

In order to produce the challenge word WCH, the processing unit 11 of the electronic device 10 adds (modulo n=10) the value of the index Ixdj indicating the symbol of the j^{th} character (or character in position j) of the candidate word WCD with the value of the field ICj of the piece of input information. The resultant index value Ixcj indicates the symbol of the j^{th} character WCHj of the challenge word. This is recorded in the data structure 12d.

Thus, with reference to FIGS. 1, 2 and 4, a preferred example of a method 100 for generating a challenge word WCH implemented by the electronic device 10 comprises a first step 121 for producing a candidate word WCD comprising m=4 characters WCD1 to WCD4, each consisting of a value or symbol selected from the organized list of n=10 predetermined symbols S1, S2, . . . , S10. A step of this kind 121 thus consists of recording a representation WCD′ as described above in a data structure 12b within the storage means 12 of the electronic device 10. Thus, each field WCD1′ to WCD4′ comprises an index value Ixd1 to Ixd4 indicating one of these symbols of the organized list of predetermined symbols. By way of example, let us consider that the step 121 consists of producing a candidate word WCD consisting of “3 9 1 9”. The first field WCD1′ thus comprises a value Ixd1 equal to the integer value four for indicating the symbol ‘3’. The second field WCD2′ for its part has a value Ixd2 equal to the integer value ten, so as to indicate the symbol ‘9’, and so on for the other characters of said candidate word. In order to select the symbol associated with each character of the candidate word WCD, the step 121 can for example implement a pseudorandom drawing of a value between 1 and n=10 on the basis of a seed generated by a random generator or a counter within the processing unit 11 and a key recorded in the storage means 12 or 13.

A method 100 according to the invention therefore comprises a step 122 for triggering the means 16 (if the latter are separate from the processing unit 11) for controlling the output interface 1D of the electronic device 10. Within the scope of a non-limiting example of a device 10 consisting of an electronic watch, the output interface 1D consists of a screen. The processing unit 11 transmits a command od1 to output content so as to bring about the output of the content of the candidate word WCD, for example in the form of a graphical display. The user U of the watch 10 can therefore visualize the content of the candidate word WCD.

The step 122 also consists of producing, encoding, and transmitting by the communication means 14 a solicitation message Md intended for an input peripheral 20, for example a smartphone adapted in accordance with the invention, as will be studied subsequently on the basis of the description of an exemplary method 200 for generating a piece of input information IC with reference to FIG. 3. A connection N1, for example according to Bluetooth technology, is initiated between the watch 10 and the phone 20 of the user U. The user activates his phone and performs the actions Au detected by the interface 2D of said phone and expressed in the form of a piece of input information IC. In accordance with our preferred example described with reference to FIG. 4, the user U has a graphical interface IDV, for example in the form of one or more encoding wheels displayed by the interface 2D, allowing the user to choose a relative step in respect of the organized list of predetermined symbols. Thus, if the first character of the candidate word WCD corresponds to the symbol ‘3’ and the first character of the secret word S to be produced by the user is ‘8’, said user can actuate the encoder wheel R1 to choose a relative index step equal to ‘+5’, as indicated in FIG. 4. This means that the user U considers that the character of the challenge word must correspond to the symbol recorded in the organized list five positions further on (modulo the number n=10 of possible symbols) than the symbol ‘3’ of the first character WCD1 of the candidate word WCD, that is to say the symbol ‘8’.

The method 100 therefore comprises a step 123 for receiving an input message Mc via said communication means 14 and for decoding a message of this kind Mc and deducing therefrom the piece of input information IC produced by said input peripheral 20. A step of this kind 123 can also consist of recording said information IC in a data structure 12c within the storage means 12 of the electronic device 10.

The method 100 therefore comprises a step 130 for producing the challenge word WCH of which the character WCHj in a given position j consists of one of the n=10 predetermined symbols S1, S2, . . . , Sn contained in said organized list stored at 12a. The symbol associated with said character WCHj is indicated by an index value Ixcj which is a function of that Ixdj indicating the value of the character WCDj of the candidate word WCD in the same position j and of the input information IC. Thus, in accordance with FIG. 4, the symbol ‘6’ of the second character WCH2 is generated in step 213 by adding, modulo n=10, the value of the index Ixd2 equal to the integer value 10, to which the processing unit 11 adds the relative integer value −3 provided by the input information IC. The resultant value stored in the structure 12d assumes the value 7, which corresponds to the symbol ‘6’ in the organized list stored at 12a.

In accordance with the example shown in FIG. 4, the graphical interface IDV has as many encoder wheels Rj as characters of the future challenge word WCH to be produced. In this case, the information IC is composite information, that is to say it comprises as many fields IC1 to ICm as there are characters of the candidate word WCD. The input message Mc thus comprises the relative increments associated with each character of said candidate word WCD. In a variant, said graphical interface IDV could comprise just a single encoder wheel. In this case, steps 122 to 125 would be implemented iteratively (situation shown in FIG. 2 by the line 126y), such that m successive input messages Mc can be decoded in step 123 and thus make it possible to produce all the m characters of the challenge word WCH.

In addition, the invention provides a plurality of embodiments for managing a situation in accordance with which a character of the secret word S, and therefore of the future challenge word WCH produced in step 124, would be identical to that of the candidate word generated in step 121. A first possibility lies in that the user U chooses a step or increment of zero via the graphical interface IDV. In a variant the method 100 can be adapted such that the step 124 for producing a character WCHj of the challenge word WCH in the position j consists in that the value of said character WCHj assumes the value or is associated with the same symbol as the character WCDj in position j of the candidate word WCD if no input message Mc is received by the communication means 14 of the electronic device 10 at the end of a specific waiting period T1, measured starting from the transmission of the solicitation message Md in step 122. A period of this kind T1 can be parameterized advantageously so as to last from one second to several seconds, for example.

In order to provide return information to the user U so that said user can be sure that his/her user action Au has been taken into consideration by the input peripheral 20 and then by the electronic device 10, a method 100 for generating a challenge word WCH in accordance with the invention can comprise a step 125 for triggering the means 16 for controlling the output interface 1D and for output by said interface 1D of the character WCHj of the challenge word WCH produced in step 124 instead of the character WCDj in position j of the candidate word WCD. This situation is illustrated by way of non-limiting example by FIG. 4. In fact, in its right-hand part, FIG. 4 describes a graphical display provided by the interface 1D in response to a sequence of display commands od1 produced by the processing unit 11. Thus, following the step 122, that is to say at the moment referenced t0 in FIG. 4, the candidate word WCD of which the four characters are associated respectively with the symbols ‘3’, ‘9’, ‘1’ and ‘9’ is provided graphically by the interface 1D. The user positions the encoder wheel R1 and selects a relative increment ‘+5’ so that, mentally, he/she can substitute the symbol ‘3’ of the first character WCD1 of the candidate word at WCD with the symbol ‘8’ of the first character of the secret word S, which he/she knows. As the first character WCH1 of the challenge word WCH is generated, the symbol chosen for said character WCH1 (that is to say the symbol ‘8’ in this case) replaces the symbol ‘3’ previously associated with the character WCD1. The user U can thus visually validate that his/her increment selection performed via the encoder wheel R1 has been taken into consideration. So as not to give a malicious third-party the opportunity of seeing the symbol of the first character of the secret word S, the method 100 also provides that, once a specific waiting period T2 (for example half a second) has elapsed, the step 125 consists of triggering the means 16 for controlling the output interface 1D in order to output, by said interface 1D, a neutral symbol instead of said produced character WCHj, that is to say, in the non-limiting example described with reference to FIG. 4, a star: “*”. Thus, at the moment t1, the word provided by the interface 1D has the content “* 9 1 9”. FIG. 4 also describes, at the moment t2, that, after the action of the user U via the encoder wheel R2, the symbol associated with the second character of the secret S substituted, after its generation in step 124, with the symbol of the second character WCD2 of the candidate word WCD is replaced by a neutral symbol once the specific waiting period T2 has elapsed, and so on for the third and fourth characters of the produced challenge word WCH. Once all of the m characters of the challenge word WCH have been produced (situation described by the link 126n), that is to say at the moment t4, the word provided by the output interface 1D describes m neutral symbols, that is to say: “* * * *”. The challenge word WCH is thus formed in a step 130 and possibly recorded in the memory 12e. Thanks to this clever embodiment, the user U can visualize that the electronic device 10 has taken into consideration the increment selection made by said user with each actuation of an encoder wheel Rj of the graphical interface IDV provided by the output interface 2D of the input peripheral 20.

In the description of an electronic device 10 according to the invention with reference to FIG. 1, we have discussed a preferred embodiment in accordance with which a device 10 of this kind can comprise a sensor 17 for cooperating with the user U of said electronic device 10 and measuring a physiological variable of said user U. So as to ensure that the challenge word WCH advantageously cannot be produced in step 130 by the processing unit 11 of said electronic device 10 whilst said electronic device is in direct contact with, or in the immediate vicinity of its assigned user U, said method 100 can advantageously comprise a step (not shown in FIG. 2), prior to said step 130, for collecting and analyzing information provided by the sensor 17 and confirming that the electronic device 10 is indeed in the direct vicinity of said user U. If not, the word WCH previously recorded in the storage means 12 is deleted from the structure 12e. A deletion of this kind can consist for example of recording a predetermined value, for example a value of zero, characterizing a deletion of this kind. In a variant or in addition, an optional step of this kind of interrogation of the sensor 17 can influence the implementation of the step 121 for producing the candidate word WCD, or the implementation of steps 122, 123 and/or 124. A security step of this kind can lie in verifying a continuity of the pulse of the user for example, or any other physiological continuity.

The invention also provides an improvement in accordance with which a supplemental “pairing” procedure between the electronic device 10 and its assigned user U can be implemented during the first application of said electronic device 10 in the immediate vicinity of said user U or against the user's body. A pairing procedure of this kind can consist advantageously, but not exhaustively, of the enrollment of a physiological variable of said user U, or verification of a physiological variable, for example the capturing of a digital fingerprint or retinal scan, these having already been included. This procedure (not shown in FIG. 2) makes it possible to perform a test of the continuity of the immediate proximity of the electronic device 10 to its user U during the implementation of the method 100. If said continuity is not interrupted, the challenge word WCH produced during a previous request for production of a challenge word does not require a new production 130 of said challenge word WCH via an action Au of said user at the input peripheral 20. The content of the challenge word WCH currently stored in the data structure 12e remains in force and relevant. By contrast, as soon as a loss of continuity of the immediate vicinity of the electronic device 10 to its user U is detected by the processing unit 11, the content of said challenge word stored in step 130 of said method 100 in the data structure 12e is deleted. The method 100 consists of implementing again the steps 121 for producing a candidate word WCD and then generating 123 and 124 the characters WCHj of the challenge word WCH. A continuity test of this kind can thus consist, when the sensor 17 confirms immediate proximity of the electronic device 10 to its user U, of reading the value of the challenge word stored in the structure 12e within the storage means 12. If said value is different from the predetermined value characterizing a deletion thereof, this means that the continuity is confirmed. Any other combination would lead to a negative result of said continuity test.

As shown in FIG. 1, the generation of a challenge word WCH by an electronic device 10 according to the invention can be triggered by the receipt of a request originating from a third-party electronic entity 30. In accordance with a possible connection N2 between said entity 30 and said electronic device 10, the latter can comprise communication means 15 designed to transmit outgoing messages Mo, encoded beforehand by the processing unit 11 and intended for the entity 30. Reciprocally, said means 15 are designed to receive incoming messages Mi transmitted by said entity 30 and decoded by the processing unit 11 of the electronic device 10. In this case, a method 100 according to the invention and described by way of non-limiting example by FIG. 1 comprises a step 110, prior to the step 121 of producing a candidate word WCD, of receiving, via the communication means 15, an incoming message Mi transmitted by said third-party entity 30 requesting the production of the challenge word WCH. The step 110 also consists of decoding said message Mi. An incoming message Mi of this kind can advantageously comprise an identifier characterizing the entity 30. An identifier of this kind can consist for example of a public key specific to the entity or of a unique address. A message Mi can also comprise additional application-related data, for example and non-exhaustively an identifier of the transaction concerned by said request for production of a challenge word, a currency amount of a financial transaction, etc. The step 110 therefore consists of deducing, from said incoming message Mi, said identifier of said third-party electronic entity 30 or said additional data. At the end of the implementation of the step 130 of generating the challenge word WCH, a method 100 of this kind can also comprise a step 140, subsequent to said step 130, for generating an outgoing message Mo encoding the produced challenge word WCH and for triggering the transmission thereof by the communication means 15 to the entity 30 having requested the production of said challenge word. In the case in which an identifier of said entity consists of a public key, the step 140 can consist advantageously of encrypting said outgoing message Mo with the aid of said identifier. Thus, only the entity 30 can decrypt said outgoing message Mo with the secret key corresponding to the transmitted identifier. Any other security, encrypting and/or signing measure could be implemented by said device 10 and the entity 30 in order to exchange the outgoing messages Mo and incoming messages Mi securely. Thus, instead of an action 140 aimed at exporting the challenge word WCH, even though this might be encoded, an action alternative or additional to said step 140 could consist of a process of signing a transaction or more generally a challenge with the aid of the value of the produced challenge word WCH.

In addition, in accordance with an embodiment implementing a continuity test of the immediate proximity of the electronic device 10 to its user U, the invention provides that the method 100 can comprise a step (not shown in FIG. 2), prior to the step 140, influencing the execution thereof. An additional step of this kind would consist of performing an action on the part of the user with the intentional objective of accepting the use of the challenge word WCH of which the value is already recorded in the data structure 12e and was produced beforehand, for example several hours beforehand, taking into account the continuity of the proximity of the electronic device 10 to its user U. A step of this kind could consist for example of waiting for the user U to perform a specific actuation of an input interface (not shown in FIG. 1) of the electronic device 10 when the latter comprises such an interface, so as to confirm the intentions of the user. An input interface of this kind could consist of a keyboard or a microphone or, more generally, any means allowing a human being to interact with the electronic device 10. The absence of an actuation of this kind indicates a voluntary acceptance by the user U of the use of the challenge word WCH, but could be considered as signifying a rejection. The step 140 or any other equivalent step utilizing said challenge word WCH could advantageously be prohibited by the electronic device 10. A situation of this kind could also be supplemented by a deletion of the value of the challenge word WCH in the storage means 12 so as to force production of a new challenge word WCH by soliciting an input peripheral so as to obtain a new piece of input information IC.

The invention also provides a variant of implementation of a method 100 according to the invention. In fact, in accordance with the advantageous embodiments described above, at the end of the production of the challenge word WCH in step 130, said challenge word can be transmitted in a step 140. In order to also maintain the confidentiality of the challenge word WCH, an advantageous embodiment could consist of not transmitting a message Mo encoding said challenge word WCH, but instead a message Mo encoding certification data that can be utilized by a remote entity 30, such that said entity can assure relevant production of said challenge word by said electronic device 10 in respect of a secret S, without the electronic device 10 transmitting the value of said challenge word WCH to said entity 30. For this purpose, in a prior step not described in FIG. 2, said entity 30 and the electronic device 10 store the same reference word WR in the respective storage means, said reference word corresponding structurally to a candidate word WCD and advantageously being secret. In addition, certification data of this kind would consist jointly of the input information IC deduced from step 123 and describing a spacing between the candidate word WCD and the secret S, and of a word WD describing a distance or discrepancy between said candidate word WCD, produced in step 121, and said reference word WR. A word WD of this kind describing a distance or discrepancy can, similarly to the information IC, comprise a plurality of fields each encoding an index increment describing a relative piece of information in respect of the candidate word WCD. Any other information WD for characterizing a distance between the reference word WR and the candidate word WCD could be utilized in a variant. It is sufficient that said information WD allows the entity 30, knowing the value of the reference word WR and said information WD, to obtain the content of the candidate word WCD without said word having to be transmitted as such. Said entity 30, on the basis of the certification data IC and WD, can thus determine if the electronic device 10 has produced a relevant challenge word WCH in respect of the secret S. The latter could also be produced dynamically by the entity 30 and could be displayed or provided to the user U by any means prior to the implementation of the method 100.

In order to produce a piece of input information IC utilized by an electronic device in accordance with the invention, such as the device 10 described with reference to FIG. 1, implementing a method 100 for generating a challenge word WCH described with reference to FIG. 2, a system according to the invention comprises an input peripheral 20. The latter must be suitable for implementing a method 200 for generating said input information IC in accordance with the present invention. A preferred, but non-limiting, exemplary embodiment of a method 200 of this kind is described with reference to FIG. 3.

With reference to FIGS. 1, 3 and 4, a method 200 of this kind is implemented by the processing unit 21 of an input peripheral 20. Said method 200 comprises a first step 210 for receiving a solicitation message Md transmitted from an electronic device 10 according to the invention and in communication with said input peripheral 20 by means of a wireless connection N1, via Bluetooth or ZigBee technologies for example, or by means of a wired connection N1, via USB, FireWire or equivalent protocols. Upon receipt of a message Md via the communication means 24 of the said input peripheral 20, the step 210 consists of decoding a message of this kind Md and deducing therefrom a request for production of a piece of input information IC. This step 210 advantageously constitutes a triggering event for the implementation of a series of subsequent steps. However, any other triggering factor could be used instead of, or in addition to a step of this kind 210. Among said subsequent steps, a step 213 consists of producing said input information IC on the basis of an item of user input data id2 provided by the input interface 2D of said peripheral 20, via the means 26 for controlling said interface 2D, manifesting an action Au exerted by a user U of said input peripheral 20. We will also detail, further below, how an action Au of this kind can be exerted by said user U. In any case, a method 200 according to the invention ultimately comprises a step 220 for generating an input message Mc encoding the input information IC produced in step 213 and intended for the electronic device 10 and for triggering the transmission of said input message Mc by the communication means 24 of the input peripheral 20.

So that the user U can perform a relevant action Au, a method 200 according to the invention can advantageously comprise a step 211, prior to the step 213, for triggering, by output commands od2, the means 26 for controlling the output interface 2D of said input peripheral 20. In response to commands of this kind od2, said interface 2D can display a device or interface, advantageously a graphical interface IDV, as described by way of non-limiting example by FIG. 4. As discussed further above, a graphical interface of this kind ITV allows the user U of the input peripheral 20 to perform an action Au that is detectable by the input interface 2D and to indirectly indicate a symbol from those contained in the list of predetermined symbols stored in the memory 12a of the electronic device 10. The user U can thus specify a virtual displacement of the index Ix indicating a symbol in said list with respect to the current value of said index indicating the symbol associated with the character of the candidate word WCD provided by the output interface 1D of the electronic device 10.

Thus, as shown by way of non-limiting example in FIG. 4, a graphical interface provided by the interface 2D can consist of one or more encoder wheels Rj having a plurality of relative index steps or increments indicating a symbol in said organized list of possible symbols. The value of said relative step selected by the user U consists of an item of input user data id2 provided by the input interface 2D manifesting the action Au of the user U via the input interface 2D. Said item of input data id2 constitutes a component or the totality of the input information IC. A piece of information of this kind IC is thus formed by data relating to an index indicating a symbol associated with a character of the candidate word. Thus, even if a piece of input information IC is intercepted maliciously, without the knowledge of the candidate word WCD it is impossible to reproduce a correct challenge word WCH. The graphical interface IDV described with reference to FIG. 4 constitutes merely a non-limiting example. An interface IDV of this kind could comprise merely a single encoder wheel or any other graphical representation, for example one or more pushbuttons crediting a counter of which the final value determines a relative increment or step, that is to say a positive integer value, a value of zero, or a negative value.

The invention also provides an embodiment of a system according to the invention in accordance with which the input interface 2D of the input peripheral 20 can be reduced to its simplest expression, for example in the form of a single virtual or physical button. In accordance with this embodiment, the input information IC can be summarized as a characteristic value expressing a command to stop a scrolling through symbols, character by character WCDj of the candidate word WCD, provided by the interface 1D of the electronic device 10. A scrolling of this kind is implemented by the output interface 1D of said electronic device 10 at the instigation of output commands od1 produced by the processing unit 11 of the same electronic device 10. Thus, in accordance with this embodiment, after generation of a candidate word WCDj in step 121 of a method 100, as described with reference to FIG. 2 and implemented by the processing unit 11, the step 122 of said method 100 causing the output of said candidate word WCD to the user U via the output interface 1D is designed such that the output commands od1 cause an iterative replacement of the symbol associated with a character of the candidate word WCD with one of the predetermined symbols provided by the organized list of possible symbols. The current content of the candidate word WCD thus becomes dynamic under the action of the scrolling. When the user U sees a symbol suitable for said character WCDj of the candidate word WCD, the user U can actuate the input interface 2D of the input peripheral 20, for example a virtual or physical pushbutton. The input information IC is then encoded in the form of an input message Mc and is then transmitted in a step 220 of a method 200 implemented by the processing unit 21 of the input peripheral 20. Upon receipt of said message Mc by the communication means 14 of the electronic device 10, the step 123 of the method 100 allows the processing unit 11 of the said device 10 to decode said message Mc and deduce therefrom said input information IC. The step 124 of said method 100 generates a challenge word WCH of which the character is associated with the symbol in turn associated with the character in the same position of the candidate word WCD. The step 125 thus consists of stopping the scrolling in order to freeze the symbol selected by the user U and then replace it with a neutral symbol. A next character of the candidate word WCD is then selected and subjected to a scrolling of symbols, and so on, until all of the characters of the candidate word WCD have been selected. Step 130 producing the challenge word WCH is implemented as described above with reference to FIG. 2.

The invention has been described on the basis of a preferred example with reference to FIGS. 1 to 4, in accordance with which an electronic device 10 consists of an electronic watch and an input peripheral 20 consists of a smartphone. Any other type of electronic object could be utilized, as long as it can be adapted for implementation of a method 200 for generating a piece of input information IC or a method 100 generating a challenge word WCH according to the invention. In addition, we have presented a secret word S, a candidate word WCD, and a challenge word WCH, the respective contents of which comprise four characters each associated with an alphanumerical symbol. It should be remembered that the invention is not to be limited by this sole example. Any other size of word and any other type of symbol could be utilized in order to implement the invention. The same is true for the examples of graphical output IDV allowing a user U to choose a relative increment.

1. A method (100) for generating a challenge word (WCH) implemented by a processing unit (11) of an electronic device (10) further comprising an output interface (1D), means (16) for controlling said output interface (1D), first communication means (14) for cooperating with an input peripheral (20), first storage means (12), and a sensor (17) for cooperating with the user (U) of said electronic device (10) and measuring a physiological variable of said user (U), said means (16) for controlling said output interface (1D), said first communication means (14), said first storage means (12), and said sensor (17) cooperating with said processing unit (11), said method (100) being characterized in that it comprises:
a step of collecting and analyzing the information provided by the sensor (17) and confirming that the electronic device is in the direct vicinity of said user (U);
a step (121) of producing a candidate word (WCD, WCD′) comprising a character (WCD1, WCDm) consisting of a value selected from an organized list (12a) of n predetermined symbols (S1, S2, . . . , Sn) indicated individually by the value of an index (Ix), n being an integer greater than one, said list being stored in the first storage means (12);
a step (122) of triggering the means (16) for controlling the output interface (1D) and outputting said candidate word (WCD) via said interface (1D);
a step (123) of receiving an input message (Mc), via said first communication means (14), and of decoding a message (Mc) of this kind and deducing therefrom a piece of input information (IC) produced by said input peripheral (20);
a step (130) of producing the challenge word (WCH) of which the character (WCHj) in a given position (j) consists (124) of one of the predetermined symbols (S1, S2, . . . , Sn) contained in said organized list (12a), said symbol being indicated by an index value (Ixcj) that is a function of that (Ixdj) indicating the value of the character (WCDj) of the candidate word (WCD) in the same position (j) and of the input information (IC).

2. The method (100) according to claim 1, for which the step (130) of producing the challenge word (WCH) also consists of recording the value of said produced challenge word (WCH) in the first storage means (12, 12e).

3. The method according to claim 2, comprising a step of replacing the value of the challenge word (WCH) recorded in the first storage means (12, 12e) by a predetermined value characterizing a deletion if the step of collecting and analyzing the information provided by the sensor (17) confirms that the electronic device is not in the direct vicinity of said user (U).

4. The method (100) according to claim 3, comprising a step (122) of generating a solicitation message (Md) intended for the input peripheral (20) and of triggering the transmission of said solicitation message (Md) by the first communication means (14).

5. The method (100) according to claim 3, for which the electronic device (10) also comprises second communication means (15) for cooperating with a third-party entity (30) requesting an authentication procedure on the basis of the challenge word (WCH), said method (100) comprising:
a step (110), prior to the step (121) of producing a candidate word (WCD), of receiving, via the second communication means (15), an incoming message (Mi) transmitted by said third-party entity (30) requesting the production of the challenge word (WCH), so as to decode said message (Mi) and so as to deduce therefrom an identifier of said third-party entity (30);
a step (140), subsequent to the step (130) of producing said challenge word (WCH), of generating an outgoing message (Mo) encoding the challenge word (WCH) and of triggering the transmission thereof (Mo) by the second communication means (15).

6. The method according to claim 5, for which:
the steps (121, 130) of, respectively, producing a candidate word (WCD, WCD′) and/or the challenge word (WCH) are implemented only if the value of the challenge word (WCH) recorded in the first storage means (12, 12e) is equal to the predetermined value characterizing a deletion;
the step (140) of generating an outgoing message (Mo) consists of reading the value of the challenge word (WCH) into the first storage means (12, 12e) prior to the encoding of said challenge word in order to generate the outgoing message (Mo).

7. The method according to claim 5, for which the step (140) of generating an outgoing message (Mo) is implemented only if the step of collecting and analyzing the information provided by the sensor (17) confirms that the electronic device is in the direct vicinity of said user (U).

8. The method (100) according to claim 1, for which the candidate word (WCD) and the challenge word (WCH) comprise a plurality of characters associated respectively with one of the symbols selected from the organized list (12a) of predetermined symbols (S1, S2, . . . , Sn).

9. The method (100) according to claim 1, comprising a step (125) of triggering the means (16) for controlling the output interface (1D) and outputting, via said interface (1D), the character (WCHj) of the challenge word (WCH) produced (124) instead of the character (WCDj) in the same position (j) of the candidate word (WCD), then, once a specific waiting period (T2) has elapsed, triggering the means (16) for controlling the output interface (1D) and outputting, via said interface (1D), a neutral symbol instead of said character (WCHj).

10. The method (100) according to claim 1, for which the step (124) of producing a character (WCHj) of the challenge word (WCH) in a given position (j) consists (124) of the value of the character (WCDj) of the candidate word (WCD) in the same position (j) if no input message (Mc) is received by the first communication means (14) at the end of a specific waiting period (T1) starting from the transmission of the solicitation message (Md).

11. The method (100) according to claim 1, for which the input information (IC) comprises a value expressing a relative step in respect of the index value (Ix) indicating the predetermined symbol associated with a character (WCDj) of the candidate word (S1, S2, . . . , Sn).

12. The method (100) according to claim 11, for which the step of producing a character (WCHj) in a given position (j) of the challenge word (WCH) consists (124) of choosing one of the predetermined symbols (S1, S2, . . . , Sn) contained in said organized list (12a), said symbol being indicated by an index value (Ixcj) which is the sum, modulo the number n of predetermined symbols in said list, of the index value (Ixdj) indicating the predetermined symbol of the character (WCDj) of the candidate word (WCD) in the same position (j) and of the value expressing the relative step comprised in the input information (IC).

13. A computer program product (P1) comprising program instructions which, when they are:
stored beforehand in the second storage means (13) of an electronic device (10) comprising a processing unit (11), first storage means (12), an output interface (1D), means (16) for controlling said output interface (1D), communication means (14, 15) for cooperating with a third-party device, and a sensor (17) for cooperating with the user (U) of said electronic device (10) and measuring a physiological variable of said user (U), said control means (16), said communication means (14, 15), said sensor (17), and said storage means (12, 13) cooperating with said processing unit (11);
executed or interpreted by said processing unit (11),
cause the implementation of a method (100) for generating a challenge word (WCH) according to claim 1.

14. An electronic device (10) comprising a processing unit (11), storage means (12, 13), an output interface (1D), means (16) for controlling said output interface (1D), communication means (14, 15) for cooperating with a third-party device, and a sensor (17) for cooperating with the user (U) of said electronic device (10) and measuring a physiological variable of said user (U), said control means (16), said sensor (17), said communication means (14, 15) and said storage means (12, 13) cooperating with said processing unit (11), said electronic device (10) being characterized in that it comprises, in the storage means (13), the instructions of a computer program product (P1) according to claim 13.

15. The electronic device (10) according to claim 14, consisting of an electronic watch, the output interface (1D) of which consists of the screen of said watch.

16. A system for generating a challenge word (WCH) comprising an electronic device (10) according to claim 14 and an input peripheral able to transmit an input message (Mc) encoding a piece of input information (IC), said piece of input information (IC) being interpretable by said electronic device (10) so as to produce the challenge word (WCH) in accordance with a method according to claim 1.

17. The system according to claim 16, further comprising a third-party entity (30) requesting a procedure of authentication on the basis of the challenge word (WCH), said entity (30) cooperating with said electronic device (10).

18. A system for generating a challenge word (WCH) comprising an electronic device (10) according to claim 15 and an input peripheral able to transmit an input message (Mc) encoding a piece of input information (IC), said piece of input information (IC) being interpretable by said electronic device (10) so as to produce the challenge word (WCH) in accordance with a method according to claim 1.
